(19) United States
(12) Patent Application Publication
(10) Pub. No.: US 2014/0008417 A1
(43) Pub. Date: Jan. 9, 2014

(54) EXTRUDED BRAZING RING WITH INTEGRATED FLUX

(71) Applicant: FLUX Brazing Schweiss- und Lotstoffe USA, LLC, Eldon, MO (US)

(72) Inventors: Jasper G. J. Visser, Sunrise Beach, MO (US); Jacobus C. B. Kotzé, Somerset West (ZA)

(21) Appl. No.: 13/731,734

(22) Filed: Dec. 31, 2012

Related U.S. Application Data
(63) Continuation-in-part of application No. 13/541,443, filed on Jul. 3, 2012.

(51) Int. Cl. B23K 35/02; B23P 17/00

(52) U.S. Cl. CPC B23K 35/0222; B23P 17/00
USPC 228/56.3; 29/527.4; 29/412

(57) ABSTRACT

A brazing ring with integrated fluxing product and methods for production thereof are described. The brazing ring has a generally circular body with a plurality of channels extending between opposing faces of the ring and disposed about the circumference thereof. The channels have a v-shaped profile. The body of the ring has a generally constant thickness between inner and outer surfaces. The v-shaped profile of the channels on the outer surface is thus mimicked in a plurality of v-shaped channels on the inner surface of the ring. The ring may be formed as a continuous ring or as a c-shape. The brazing ring is formed by extruding a filler material to form a tube with the desired profile and disposing the fluxing product into the channels of the profile. The tube is subsequently sectioned perpendicular to its length to produce a plurality of the brazing rings.

### CROSS-REFERENCE TO RELATED APPLICATIONS

This application is a continuation-in-part of U.S. patent application Ser. No. 13/541,443, filed Jul. 3, 2012, the disclosure of which is hereby incorporated herein in its entirety by reference.

### BACKGROUND

Metal joining through soldering and brazing is well known in the art. Generally, soldering and brazing include flowing of a liquid filler metal into a joint between base metal components via capillary action; soldering using filler metals with melting points below about 450° C. and brazing employing filler metals with melting points above about 450° C. Various methods and materials are employed for such operations. One common example of which includes melting and flowing a lead-based solder wire into a joint between copper pipes in a household plumbing system.

It is also known to employ a fluxing product to aid in preparation of the base metals during soldering and brazing. Fluxing products aid in breaking down oxide layers on surfaces of the base metals and may protect the base metals during soldering/brazing among other benefits. The fluxing products can be applied prior to heating of the materials or might be melted and applied by the heating. The fluxing products are often incorporated with the filler material, such as interior to the filler material, e.g. flux-cored wire, or as a coating on the filler material. For example, U.S. Patent Publication No. 2009/0101238, to Jossick et al. describes coating wires comprised of filler materials with a fluxing product. Similarly, U.S. Patent Publication No. 2009/0014093, to Campbell et al. describes disposing fluxing material in a channel in a filler material wire. And U.S. Patent Publication No. 2010/0219231 to Means et al. describes filler materials formed into ring-shaped components that have channels or grooves extending laterally along the circumference of the component and that are filled with fluxing products.

Problems exist with these examples that hinder manufacturing and use of the components. Production of wire-based components requires subsequent forming steps either during manufacture or during use to cut and form the wire into a desired form, e.g. a ring. And production of ring components requires subsequent machining steps to form the channel about the circumference of the ring followed by packing or disposal of the fluxing product in the machined channel.

In use, these products fail to sufficiently wet the soldering/brazing material with flux. The soldering/brazing material thus fails to flow into the joint to be soldered/brazed because, for example, the surface tension of the melted soldering/brazing material is too high. Both wire-based and ring forms often fail to provide a sufficient snug or friction fit with a pipe or fitting on which they are installed. As such, the wire or ring components may fall off or move out of position before completion of the soldering or brazing operation. Further, due to the subsequent forming steps required and/or the restriction on the channel profiles available through machining, retention of the fluxing product in the channels can be an issue.

There remains a need for a soldering and brazing ring that is easily manufactured with an integrated fluxing product; that enables wetting of the ring by the fluxing product; and that is configured to positively retain the fluxing product to avoid dislodging of the fluxing product during handling. A soldering or brazing ring that is adaptable to variation in pipe and fitting diameter and that provides a friction fit with a pipe or fitting to aid in maintaining an installed position of the ring would also be beneficial.

### SUMMARY

Embodiments of the invention are defined by the claims below, not this summary. A high-level overview of various aspects of the invention are provided here for that reason, to provide an overview of the disclosure, and to introduce a selection of concepts that are further described in the Detailed-Description section below. This summary is not intended to identify key features or essential features of the claimed subject matter, nor is it intended to be used as an aid in isolation to determine the scope of the claimed subject matter. In brief and at a high level, this disclosure describes, among other things, an extruded brazing ring with integrated fluxing product and methods for its manufacture.

The brazing ring is intended for use in connecting two metal components together by a brazing process which as used herein is intended to include related metal joining processes such as soldering. The brazing ring comprises an annular body formed from an alloy adapted for use in a brazing process. The annular body includes opposing faces and inner and outer surfaces. A plurality of channels are formed in at least the outer surface and preferably also in the inner surface of the annular body. The inner and outer channels extend between and perpendicular to the opposing faces and in succession around the annular body. The thickness of the annular body between the inner and outer surfaces is preferably uniform.

The inner and outer channels may be described as being formed from a plurality of peaks and valleys extending around the inner and outer peripheries of the annular body respectively. The outer channels projecting outward and the inner channels projecting inward. The peaks on the outer periphery preferably extend in radial alignment with the valleys in the inner periphery and the peaks on the inner periphery extend in radial alignment with the valleys in the outer periphery. Each of the inner and outer channels may have a v-shaped profile with opposed walls forming the outer channels forming an angle of between about 45° and about 120° and more preferably between about 60° and about 105°.

At least some of the outer channels are at least partially filled with flux and in a preferred embodiment all of the outer channels are filled with flux. It is also foreseen that some or all of the inner channels could be at least partially filled with flux. The amount of flux received within the channels can be controlled in the forming process.

In one embodiment, the brazing ring is configured for manufacturing via extrusion of the filler material to form a tube of the desired cross-sectional profile. The tube is then passed to a filling apparatus for packing or disposal of the fluxing product in the channels. The tube is then cut or sectioned perpendicular to its length to produce the brazing rings in any desired thickness.

### DESCRIPTION OF THE DRAWINGS

Illustrative embodiments of the invention are described in detail below with reference to the attached drawing figures, and wherein:

FIG. 1A is a perspective view of a brazing ring with integrated flux depicted in accordance with an embodiment of the invention;

FIG. 1B is an elevational view of the brazing ring with integrated flux of FIG. 1A;

FIG. 1C is a cross-sectional view of the brazing ring with integrated flux of FIG. 1 taken along line C-C depicted in FIG. 1B;

FIG. 1D is a perspective view of the brazing ring of FIG. 1A depicted without the integrated flux;

FIG. 2A is a perspective view of a second brazing ring depicted in accordance with an embodiment of the invention;

FIG. 2B is an elevational profile view of the brazing ring of FIG. 2A with flux disposed in and partially filling channels therein;

FIG. 3A is perspective view of a third brazing ring depicted in accordance with an embodiment;

FIG. 3B is an elevational profile view of the third brazing ring of FIG. 3A;

FIG. 4A is perspective view of a fourth brazing ring depicted in accordance with an embodiment of the invention;

FIG. 4B is an elevational profile view of the fourth brazing ring of FIG. 4A;

FIG. 5 is a block diagram depicting a manufacturing line for production of a brazing ring with integrated flux in accordance with an embodiment of the invention;

FIG. 6A is a perspective view of an extruded tube having the profile of a brazing ring in accordance with an embodiment of the invention;

FIG. 6B is an elevational view depicting the profile of the extruded tube of FIG. 6A;

FIG. 7A is a perspective view of the extruded tube of FIG. 3A with flux integrated into channels therein;

FIG. 7B is an elevational view of the profile of the extruded tube of FIG. 7A;

FIG. 8 is a cross-sectional view of a pipe joint prior to a brazing operation with a brazing ring installed in accordance with an embodiment of the invention;

FIG. 9A is a perspective view of a fifth brazing ring with integrated flux depicted in accordance with an embodiment of the invention;

FIG. 9B is an elevational view of the brazing ring with integrated flux of FIG. 9A;

FIG. 9C is a cross-sectional view of the brazing ring with integrated flux of FIG. 9 taken along line C-C depicted in FIG. 9B;

FIG. 10A is a perspective view of an extruded c-shaped tube that is useable to produce the brazing ring of FIG. 9A in accordance with an embodiment of the invention; and

FIG. 10B is a perspective view of a c-shaped brazing ring produced by sectioning the c-shaped tube of FIG. 10A in accordance with an embodiment of the invention;

FIG. 11A is a perspective view of an extruded tube having a continuous wall depicted in accordance with an embodiment of the invention; and

FIG. 11B is an elevational view of a brazing ring formed by sectioning the extruded tube of FIG. 11A in accordance with an embodiment of the invention

FIGS. 12A-C are elevational views of the brazing ring of FIG. 9A with flux applied in a plurality of exemplary configurations in accordance with embodiments of the invention.

### DETAILED DESCRIPTION

The subject matter of select embodiments of the invention is described with specificity herein to meet statutory requirements. But the description itself is not intended to necessarily limit the scope of claims. Rather, the claimed subject matter might be embodied in other ways to include different components, steps, or combinations thereof similar to the ones described in this document, in conjunction with other present or future technologies. Terms should not be interpreted as implying any particular order among or between various steps herein disclosed unless and except when the order of individual steps is explicitly described.

Embodiments of the invention are described herein with respect to the drawings in which reference numerals are employed to identify particular components or features. Similar elements in the various embodiments depicted are provided with reference numerals having matching second and third digits but with differing first digits, e.g. element 10 is similar to elements 110, 210, etc. Such is provided to avoid redundant description of similar features of the elements but is not intended to indicate in any way that the elements are necessarily identical.

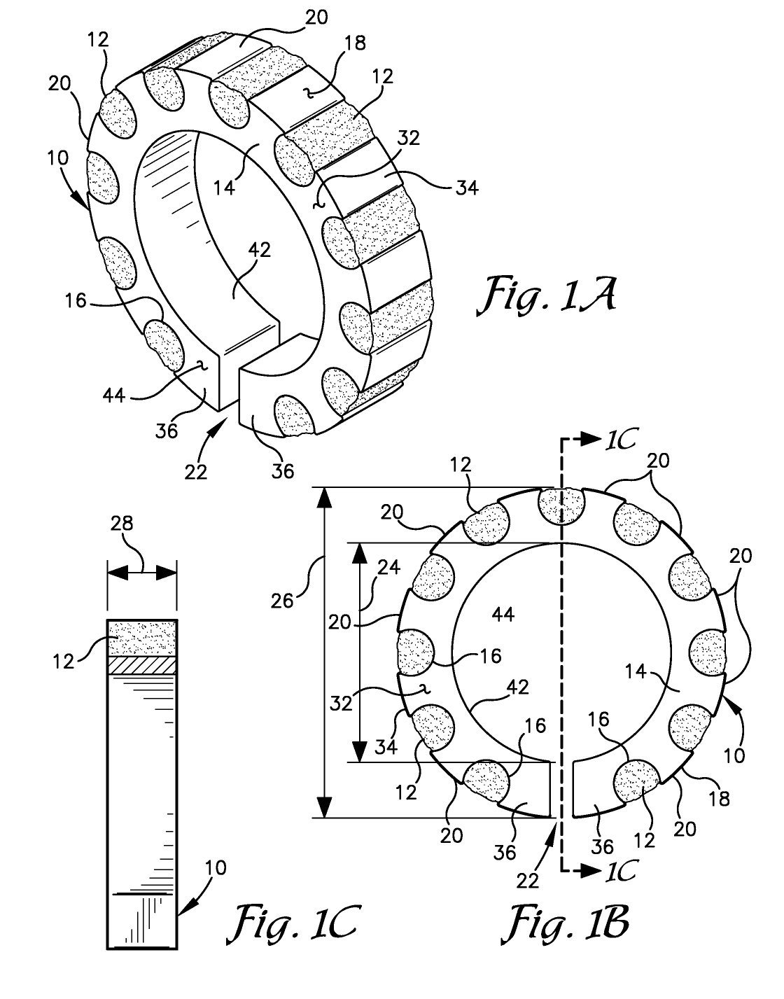

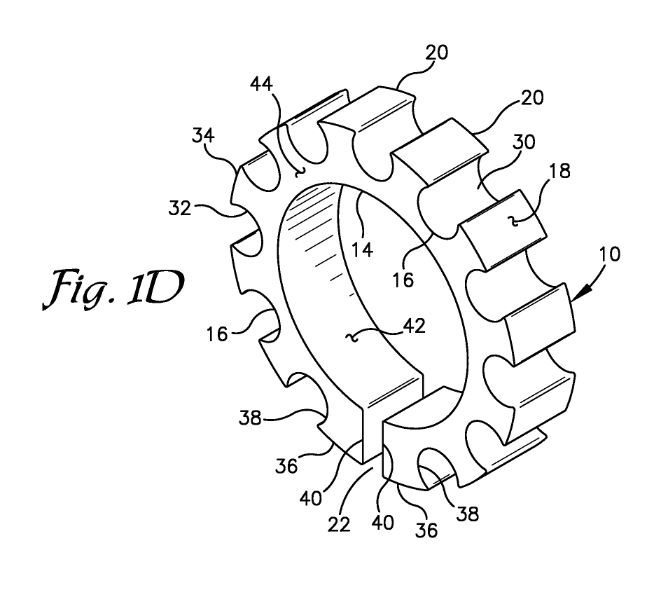

Referring initially to FIGS. 1A-D, a brazing ring 10 with integrated flux 12 is described in accordance with an embodiment of the invention (FIG. 1D depicting the brazing ring 10 without the flux 12 integrated therein.) The ring 10 is described herein with respect to brazing, however such is not intended to limit embodiments of the ring 10 to any particular joining method. As referred to herein, brazing is intended to be inclusive of brazing, soldering, braze welding, welding, and any similar joining operations in which embodiments of the ring 10 might be employed. In addition, as used herein, reference to brazing materials or alloys is intended to include alloys formulated or otherwise adapted or designed for use in brazing or soldering processes or braze welding or the like. Further, joining is described herein with respect to joining of metal components but embodiments of the invention are not so limited. Similar process of joining ceramics, plastics, or other materials with similar or dissimilar materials are understood by Applicants and are within the scope of embodiments of the invention described herein.

The ring 10 includes a body 14 with a plurality of channels 16 disposed in an outer surface 18 thereof and separated by radially extending flanges 20. The body 14 has a substantially hollow cylindrical or annular form with a gap 22 in the circumference thereof that provides a c-shaped profile. The body 14 has an inner diameter 24, outer diameter 26, and thickness 28 of any desired dimensions. In an embodiment, the inner diameter 24 of the body 14 is configured to be the same or smaller than a pipe or fitting on which the ring 10 is to be disposed. The dimensions 24, 26, 28 of the body 14 preferably are configured to provide a predetermined volume of filler material to a joint to be brazed as described below.

The body 14 is formed from one or more filler materials. The filler materials include, for example, metals like aluminum, nickel, cobalt, copper, silver, zinc, lead, and non-metals like silicon and phosphorous, however any desired filler materials might be used in embodiments of the invention. In an embodiment, the filler material includes an alloy comprising aluminum in combination with silicon or zinc or both silicon and zinc. In an embodiment, the filler material is an alloy comprising about 60-80% aluminum, about 0-15% silicon, and about 0-25% zinc, or more preferably about 70-75% aluminum, 5-10% silicon, and about 15-20% zinc, or about 72.8% aluminum, 8.7% silicon, and about 18.5% zinc, however any combination of materials can be employed as desired.

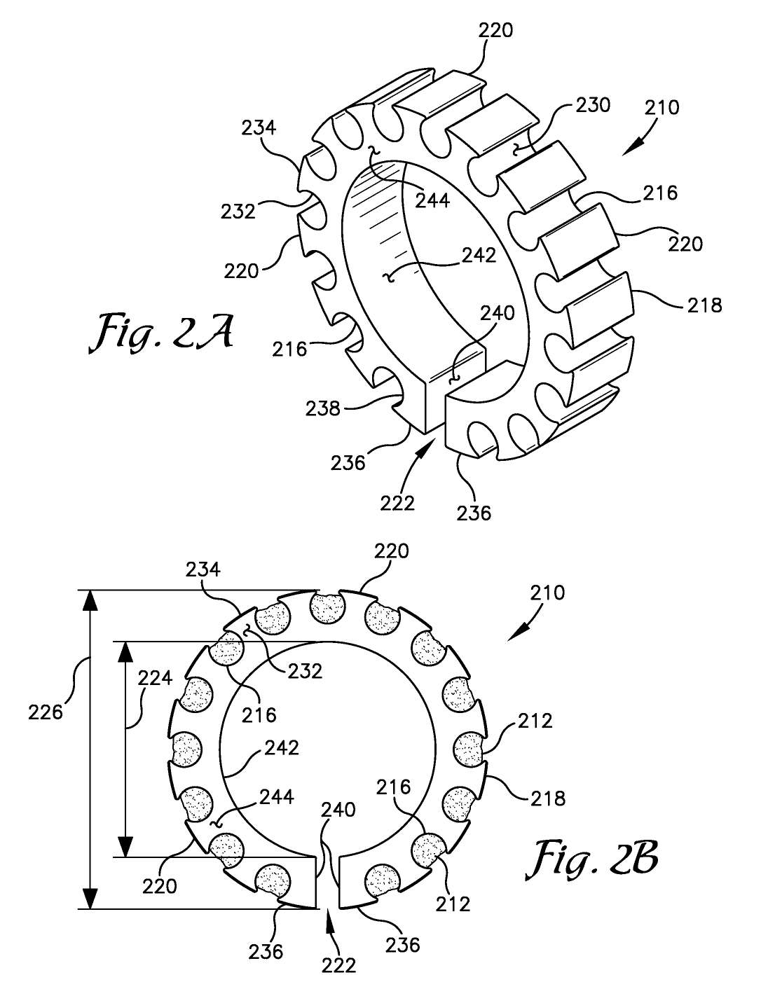

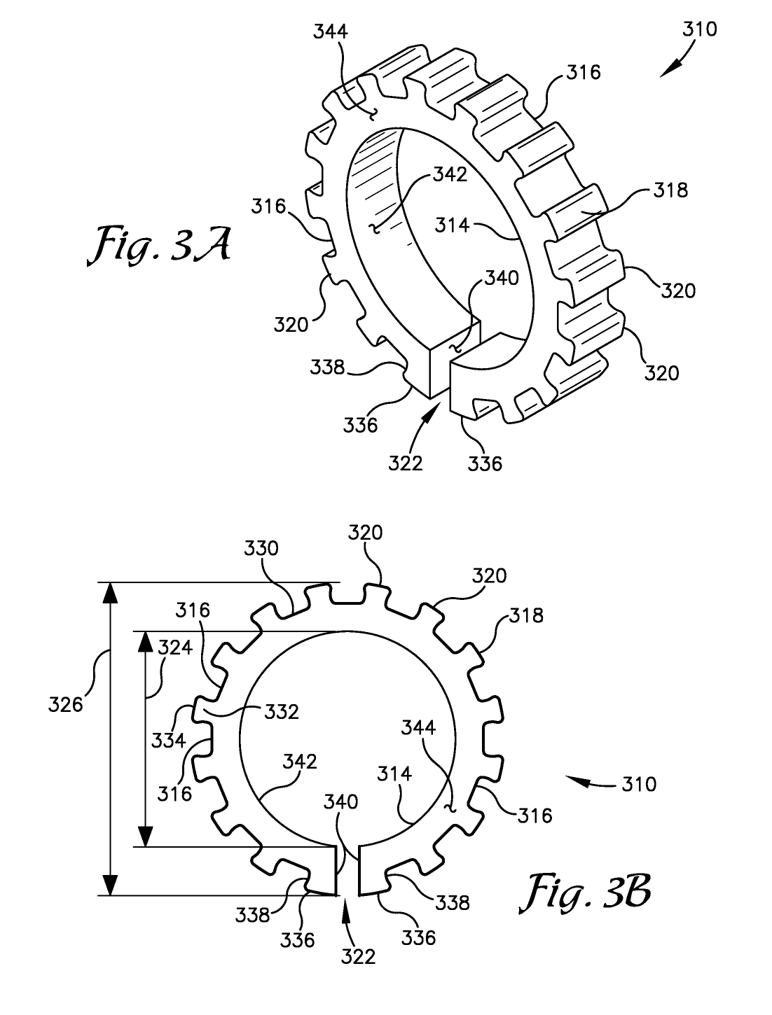

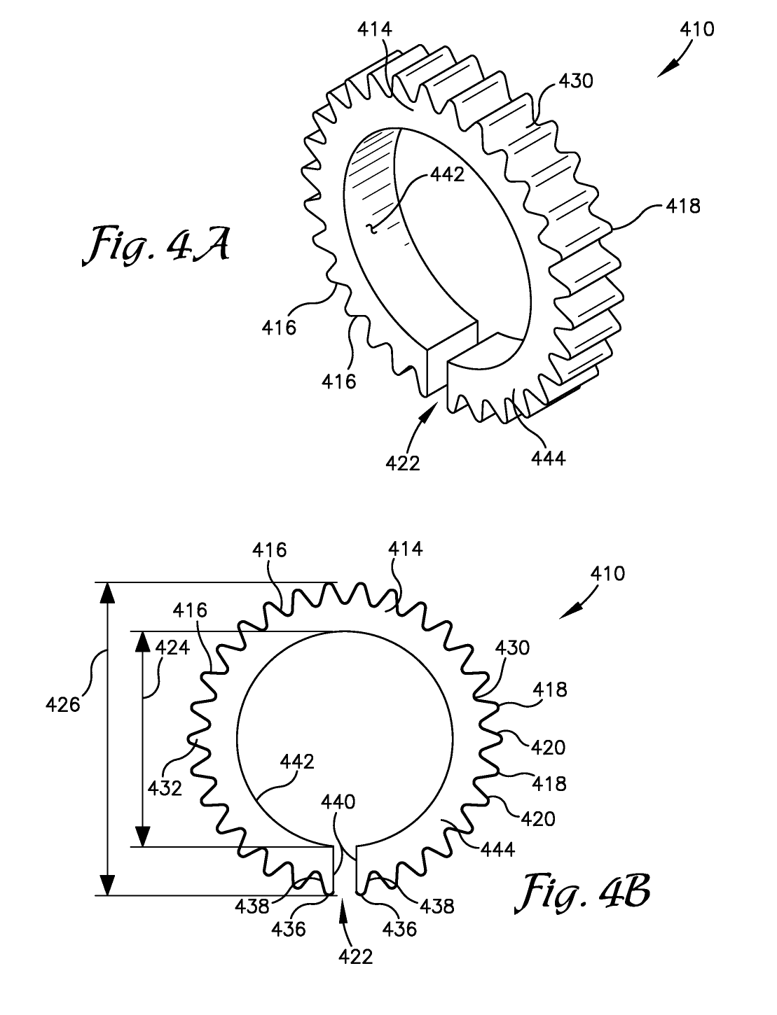

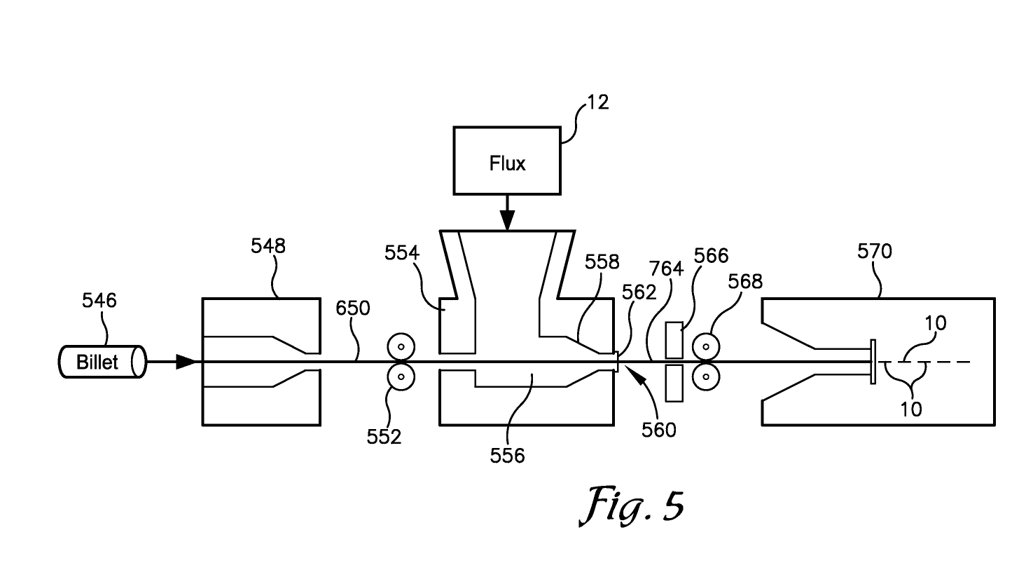

The channels 16 in the outer surface 18 of the body 14 are configured to receive and retain the flux 12 disposed therein. The channels 16 extend the full thickness 28 of the body 14 and may be of varying cross-sectional shape. In the embodiment depicted in FIGS. 1A-D and FIGS. 2A-B, the channels 16, 216 have a substantially circular cross-sectional shape. In the embodiment depicted in FIGS. 3A-B, the channels 316 have a generally rectangular cross-sectional shape with an inner face 330 defined along a circumference that is at a shorter radial distance than the outer surface 318 of the ring 310 and a pair of sidewalls 332 defined by the flanges 320. The profile of sidewalls 332 may be linear or curvilinear. Or, as shown in the embodiment depicted in FIGS. 4A-B and 9A-D, the channels 416, 916 may have a substantially triangular cross-sectional shape. As shown in the drawings, all of the channels 16 in the ring 10 have the same cross-sectional shape. However, the channels can have different shapes.

Any number of channels 16 can be included in the ring 10. In the embodiments shown, channels 16 are evenly spaced about the circumference of the ring 10, but the arrangement of the channels 16 about the circumference of the ring 10 may be varied. The number and dimensions of the channels 16 is configurable to provide a desired volume in which the flux 12 can be disposed as described below.

In an embodiment shown in FIGS. 1A-D, each flange 20 comprises a leg 32 with an enlarged distal end 34. The enlarged distal end 34 extends at least partially across or over a respective channel 16 to at least partially overhang or enclose the channel 16. As such, as depicted in FIGS. 1A-D, the circular profile of the channel 16 includes an arc of greater than 180°. As shown in FIGS. 1A-D and 2A-B the arc of the channel 16 or 216 might range between approximately 200° to 250°. As depicted in FIGS. 3A-B, the enlarged end 334 protrudes over at least a portion of the channel 316 to form an overhang.

The body 14 also includes a pair of end flanges 36 disposed on opposing sides of the gap 22. Each end flange 36 includes a first side 38 that forms a portion of an adjacent channel 16 and a second side 40 that defines the gap 22. The second side 40 is shown as a flat plane aligned along a radius of the ring 10 although, it is foreseen that other profiles might be utilized. In the embodiment shown, the end flanges 36 are larger or have a greater volume than the flanges 20. The larger volume of the end flanges 36 is adapted to provide additional filler material to compensate for the gap 22 during brazing.

The flux 12 comprises fluxing products available in the art and may include a binder to aid in retaining the fluxing products in a solid or semi-solid form. In one embodiment, the flux comprises one or more of potassium tetrafluoroaluminate and cesium tetrafluoroaluminate. In another embodiment, the flux contains a mixture of 5-50% cesium tetrafluoroaluminate and 50-95% potassium tetrafluoroaluminate.

Any available binder might be employed with the chosen fluxing products including polymers derived from petroleum, acrylics, or carbon dioxide. The binder might be one or more of a thermoplastic, a copolymer, and a polyalkylene carbonate. In one embodiment, the binder comprises QPAC® polymer beads manufactured by Empower Materials, Inc. of New Castle, Del., USA. In another embodiment, the binder is DAREX RZ11-0081-2. The binder can comprise any percentage by weight of the total fluxing product. In an embodiment, the binder comprises up to about 5% of the total weight of the fluxing product or more preferably comprises about 1 to about 1.25% of the total weight.

In one embodiment, the flux 12 is produced by dissolving the chosen binder in a solvent such as glycol or methyl ethyl ketone (MEK) and adding the fluxing products to the solution in powdered form. For example, QPAC® polymer beads might be dissolved in an MEK solvent and potassium tetrafluoroaluminate and cesium tetrafluoroaluminate powders added to the solution. As such, the flux 12 is produced in a thick paste-like form. The flux 12 can subsequently be heated to evaporate the solvent and to thereby at least partially harden the flux 12 to a desired extent.

The flux 12 completely fills the channels 16, as depicted in FIGS. 1A-C, or may only partially fill the channels 16, such as the channels 216 depicted in FIG. 2B. The flux 12 can be disposed in all of the channels 16 or one or more of the channels 16 might not be filled with the flux 12. In an alternative embodiment, more than one flux formulation 12 is used and one or more of the channels 16 are filled with different flux formulations 12. The flux 12 might also be coated on the outer surface 18, an inner surface 42, or a face 44 of the body 14.

Preferably, the amount of flux 12 disposed on the brazing ring 10 comprises at least approximately 16% by weight or approximately about 20% by weight of the finished brazing ring 10 to provide adequate flux 12 for brazing operations as described more fully below. However, greater or lesser amounts of flux 12 can be employed without departing from the scope described herein. The term “approximately” as used herein is intended to indicate possible deviations from the exact value by +/−10%, or preferably by +/−5% and/or deviations in the form of changes that are insignificant for the intended function.

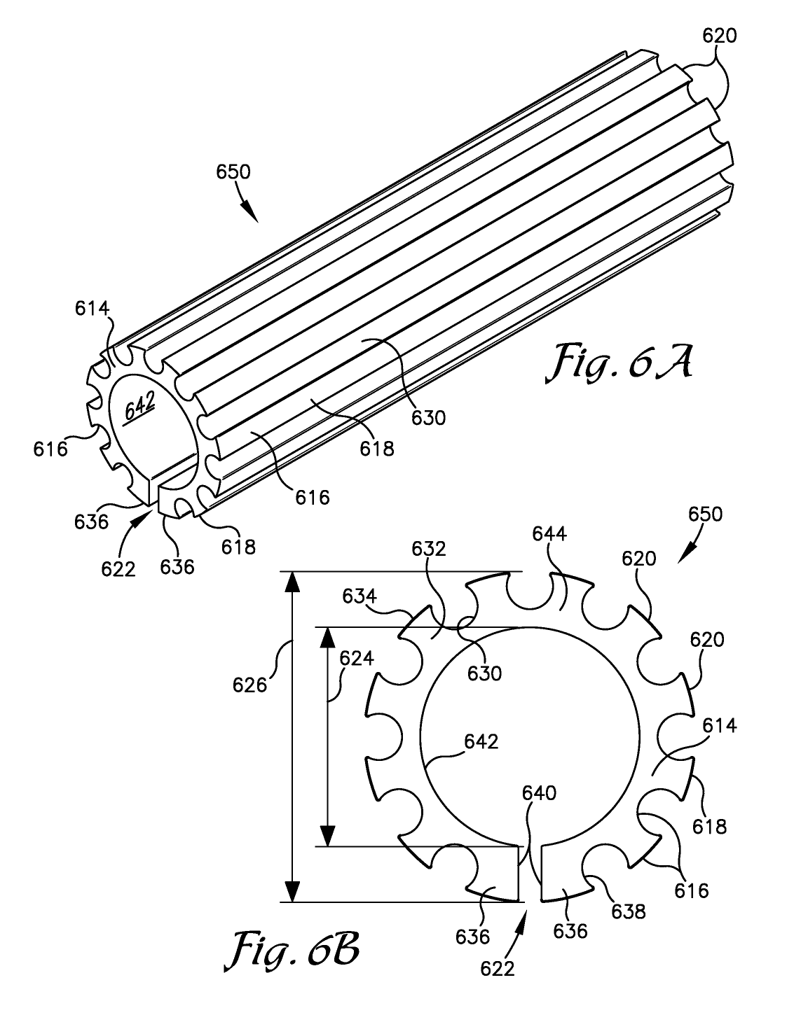

With additional reference now to FIGS. 5, 6A-B, and 7A-B, a method for producing the brazing ring 10 is described in accordance with an embodiment of the invention. Initially a billet 546 of filler material is provided. The billet 546 can be produced by any methods known in the art and has a composition desired in the final brazing ring 10. The billet 546 might also include one or more alloying elements or additives and/or be subjected to one or more heat treatments or other processes to impart material characteristics desired in the brazing ring 10 or to aid in the manufacturing processes described below. Although a billet 546 is described herein, such is not intended to limit the form of the raw filler materials used in embodiments of the invention, e.g. the filler materials might comprise powders, ingots, bars, or the like.

The billet 546 is extruded by an extrusion press 548, through a die (not shown) to form a pipe or tube 650, as best depicted by FIG. 6A, having a cross-sectional profile (depicted in FIG. 6B) matching or approximating that of the brazing ring 10. In an embodiment, the billet 546 is heated to about 500° C. for extrusion. Extrusion of the billet 546 to form the tube 650 is completed by methods known in the art.

Following extrusion, the tube 650 might be heat treated or otherwise processed to impart desired material properties. In an embodiment, the tube 650 is cooled from an approximately 500° C. extrusion temperature to approximately 450° C. at a controlled rate within about 2 minutes after extrusion. The tube 650 is also passed through one or more straightening rolls 552 and/or forming rolls, hereinafter collectively referred to as rolls 552. The rolls 552 provide straightening of deformities in the tube 650 that occur during extrusion or subsequent processing. The rolls 552 can also provide additional forming of the tube 650 to produce a desired profile. Additionally, the rolls 552 might act as drive rolls to drive the tube 650 along its path to the next stage of processing. In an embodiment, the rolls 552 receive the tube 650 directly from the extrusion press 546 during or after extrusion thereof.

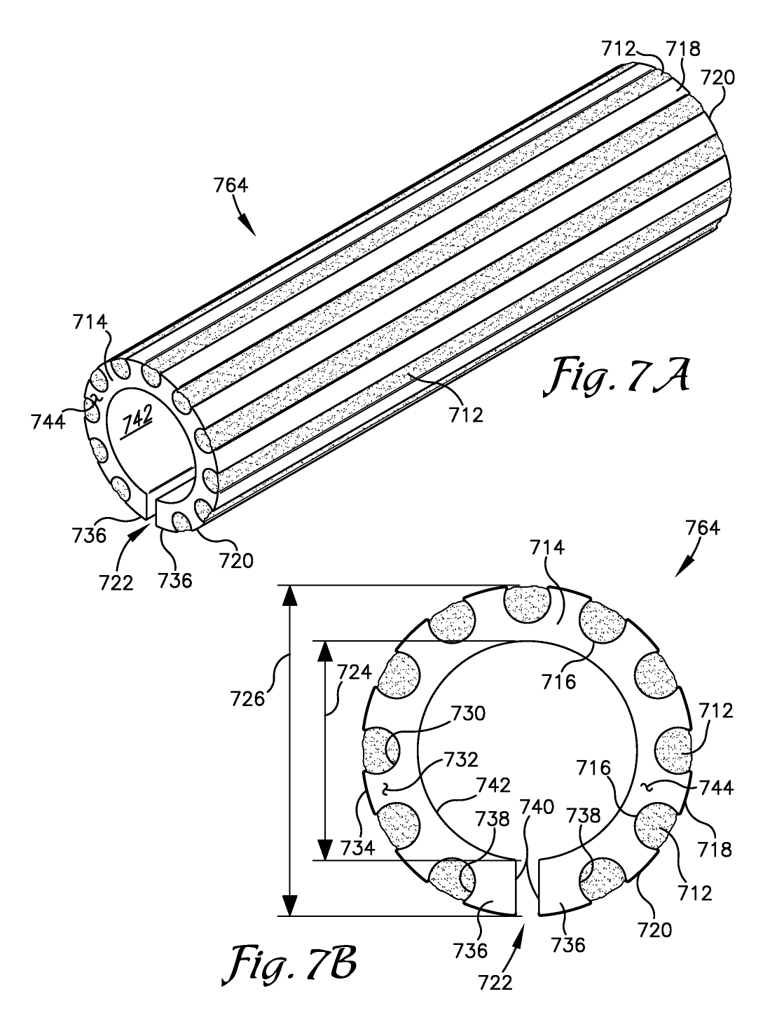

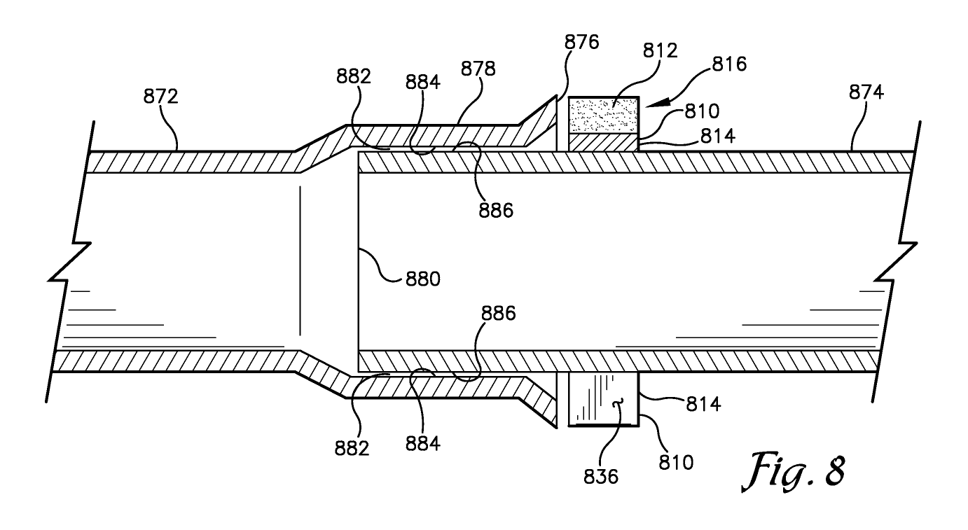

The tube 650 is advanced to a filling apparatus 554. The filling apparatus 554 includes a reservoir 556 containing the flux 12 through which the tube 650 is driven. In an embodiment, the reservoir 556 is pressurized and includes a conical portion 558 leading to an exit aperture 560. The pressurization of the reservoir 556 forces the flux 12, which is in a paste-like form, into the channels 616 of tube 650 as the tube 650 passes through the reservoir 556 to produce a tube 764 with integrated flux, as best depicted in FIGS. 7A-B. The tube 764 is identical to the tube 650 but for the addition of the flux 12 in the channels 716 thereof.

The exit aperture 560 may include one or more wiping features 562 configured to wipe the flux 12 from the outer 718 and inner 742 surfaces of the tube 764. The wiping features 562 can be configured to remove all or nearly all of the flux 12 from the surfaces 718, 742. Or the wiping features 562 might leave a coating of the flux 12 on one or more of the surfaces 718, 742 or portions thereof. In another embodiment, the wiping features 562 are configured to remove all or a portion of the flux 12 from one or more of the channels 716 of the tube 750. In such an embodiment, the tube 764 might be passed through a second filling apparatus to dispose another flux of the same or different composition in any unfilled or partially filled channels 716 in the tube 764.

After deposition of the flux 12 into the channels 716, the flux 12 is dried to remove at least a portion of the solvent contained therein. The drying is completed by passing the tube 764 through a heating element 566 that is integral with the filling apparatus 554 or that is subsequent to the filling apparatus 554 in the production line. The heating element 566 is any available heating device in the art including, for example and not limitation, radiant heating elements, heated air blowers, induction heating coils, or combinations thereof. Or drying of the flux 12 might be completed using residual heat contained in the tube 764. When the tube 764 is fed directly from the extrusion press 548 to the filling apparatus 554, the tube 764 may be relatively hot. Such residual heat might be sufficient to dry the flux 12 after disposal in the channels 716.

The tube 764 is also optionally passed through one or more second sets of rolls 568 to cure any deformities that might be incurred during processing of the tube 764. The rolls 568 might also provide one or more forming operations to impart changes in the profile of the tube 764. And the rolls 568 can draw the tube 764 through the filling apparatus 554 and/or drive the tube 764 on to subsequent production components or operations. In an embodiment, the rolls 568 are heated rolls that function as the heating elements 566 to dry the flux 12.

The tube 764 is subsequently passed to a sectioning apparatus 570 that sections the tube 764 transverse to its length to form the brazing rings 10, as depicted in FIGS. 1A-C. The sectioning apparatus 570 employs any cutting technology including, circular saw blade, band saws, knives, laser cutting, water-jet, shears, or the like. The sectioning apparatus 570 is configured to section the tube 764 to produce the brazing rings 10 in any desired thickness 28. The brazing rings 10 can be further processed to remove cutting debris, apply additional flux 12 to faces 44 of the body 14 thereof, package the brazing rings 10 for transport, or the like.

Referring now to FIG. 8, use of a brazing ring 810 to join a first pipe 872 to a second pipe 874 is described in accordance with an embodiment of the invention. The first and second pipes 872, 874 comprise any components desired to be joined by brazing, soldering, or like methods as described previously above. In an embodiment, the first and second pipes 872, 874 include components of heat exchanger coils in a HVAC (heating, ventilation, air-conditioning system). An end 876 of the first pipe 872 includes or is prepared to provide an enlarged or flared portion 878 configured to accept an end 880 of the second pipe 874. In the embodiment shown, the first pipe 872 has an inner diameter that is sufficient to accept the second pipe 874 therein. The ends 876 and 880 are cleaned of any debris or other contaminates that may have deleterious effects on the joint or brazing process.

The brazing ring 810 has an inner diameter that is the same as or slightly smaller than an outside diameter of the second pipe 874. As such, the brazing ring 810 is at least partially flexed in order to insert the second pipe 874 into the brazing ring 810. The brazing ring 810 is slidably moved into a desired position and resistance of the brazing ring 810 to the flexure provides a snug friction fit around the second pipe 874 to retain the brazing ring 810 in the desired position. In an embodiment, the brazing ring 810 is substantially rigid and is not flexed for insertion of the second pipe 874, e.g. the inner diameter of the brazing ring 810 is sufficient to accept the second pipe 874 therein. Such dimensions might be configured to provide a snug friction fit around the second pipe 874 without flexure of the brazing ring 810. The second pipe 874 is subsequently inserted into the enlarged portion 878 of the first pipe 872 and the brazing ring 810 placed at or adjacent to the end 876 of the first pipe 872.

Next, the brazing ring 810 and/or the first and second pipes 872, 874 are heated. The heating of the brazing ring 810 first causes melting of the flux 812; the flux 812 is selected or formulated to have a melting temperature that is less than the melting or solidus temperature of the filler materials. Upon melting, the flux 812 flows out of the channels 816 in the brazing ring 810 and covers or wets exposed surfaces of the brazing ring 814 and the surfaces 884, 886 of the pipe sections 872, 874 in the joint area with the liquefied flux 812. In one embodiment, the liquefied flux 812 wets substantially all exposed surfaces of the brazing ring 814 and the surfaces 884, 886 in the joint area due to the surface tension of the liquefied flux 812. The liquefied flux 812 prepares the wetted surfaces 884, 886 and/or surfaces of the brazing ring 814 by, for example, removing oxides thereon and prevents further oxidation of the wetted surfaces 884, 886. The liquefied flux 812 may also be formulated to sufficiently lower the surface tension of melted brazing ring material to enable the molten material to flow into a space 882 between the first and second pipes 872, 874.

Upon heating of the brazing ring 810 to an appropriate temperature, typically higher than the melting temperature of the flux 812, the brazing ring 810 melts. In an exemplary embodiment, the brazing ring 810 melts in progressive stages which functions to allow the liquefied flux 812 to cover all of the molten material of brazing ring 810. A combination of liquefied flux 812 and molten brazing ring material flows into the open joints by, for example, capillary action due to induced lowered surface tension. The liquefied flux 812 continues to prevent further oxidation of the molten brazing ring material during flowing. Impurities and other reactive elements are bonded into the liquefied flux 812 by chemical reaction.

The brazing ring 810 is configured to provide a volume of filler material sufficient to cover exposed surfaces 884, 886 and to fill or at least partially fill the space 882; at least a portion of the space 882 is filled about the full circumference of the second tube 874 to seal the joint, however the full longitudinal length of the space may not be entirely filled with filler material. In an embodiment, as described above, the end flanges 836 of the brazing ring 810 have a volume sufficient to fill the space 882 in the area of the gap 822, e.g. the molten filler material flows longitudinally into the space 882 and laterally across the area of the space 882 associated with the gap 822.

The appropriate melting temperature is a combination of one or more of the melting, solidus, and/or liquidus temperatures of the filler material depending on the composition of the filler material and the characteristics thereof. For example, the filler material may have a melting range in which it is partially melted. The partially melted filler material may easily flow into the space 882 or may be too viscous to do so until reaching a fully liquid state, e.g. the liquidus temperature. The appropriate temperature for flowing the brazing ring 810 into the space 882 is less than the melting or solidus temperature of the base materials that make up the first and second pipes 872, 874.

Flowing of the molten filler material into the space 882 displaces, evaporates, burns out, or otherwise removes all or part of the flux 812 on the surfaces 884, 886 of the first and second pipes 872, 874. The filler material is subsequently cooled and solidified to bond the first and second pipes 872, 874 together. Additional processes can be performed to, for example, remove excess or residual flux 812 or filler material on the pipes 872, 874, among other processes.

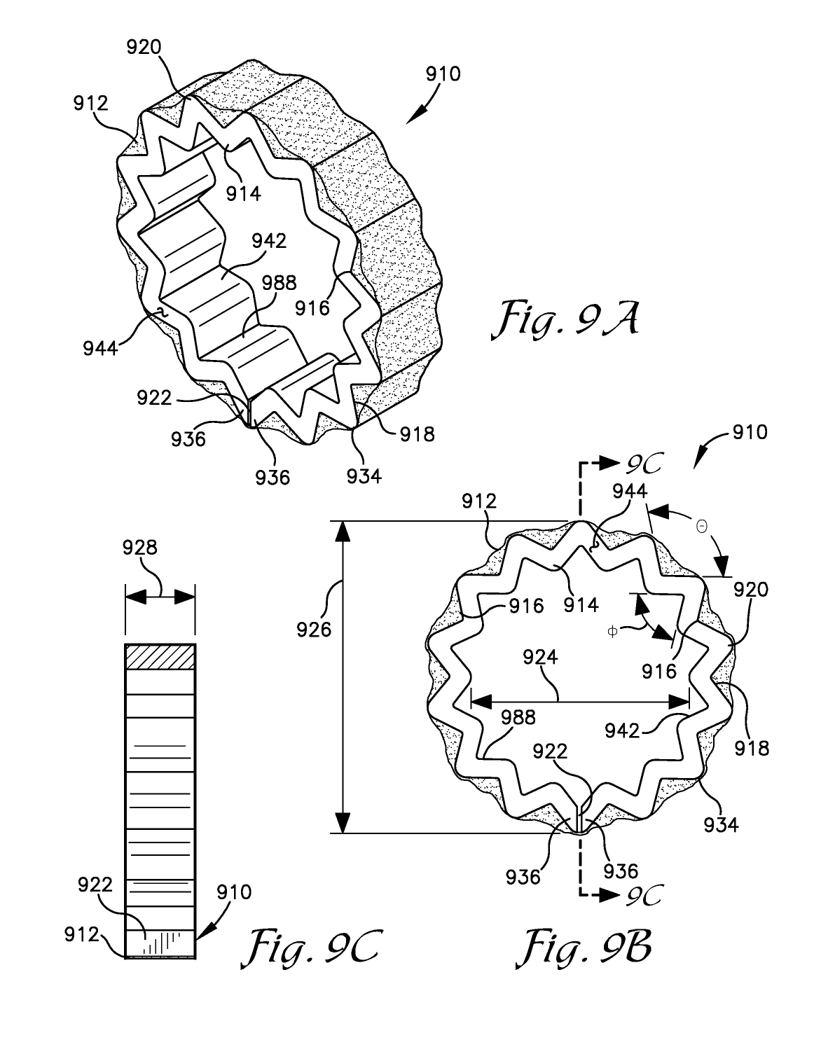

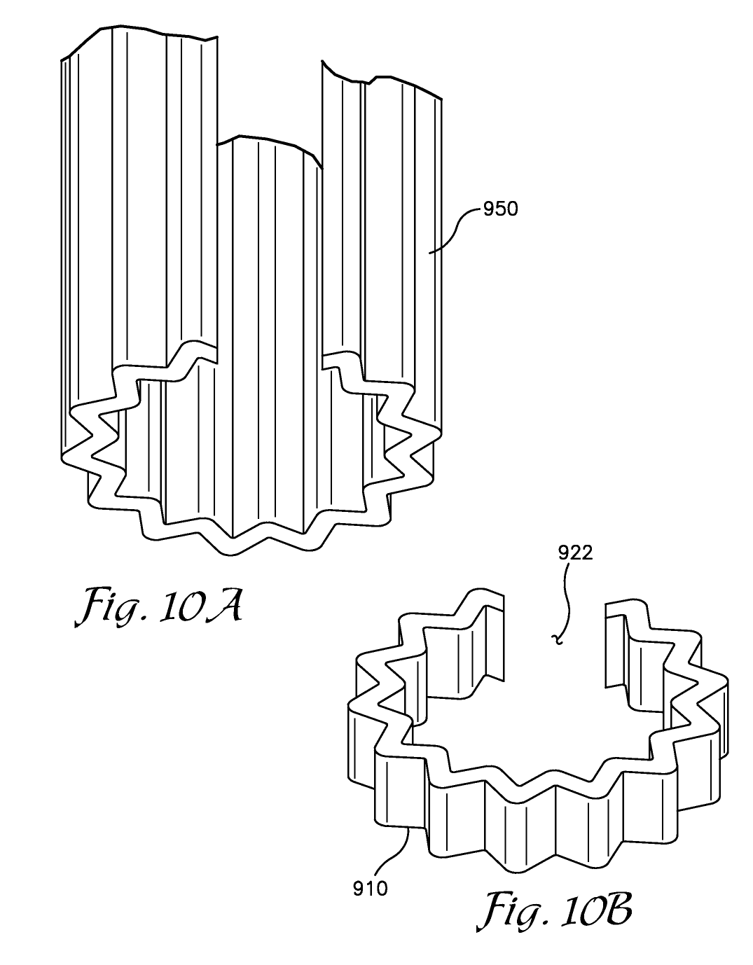

With reference now to FIGS. 9-12, a brazing ring 910 is described in accordance with another embodiment of the invention. As depicted in FIGS. 9A-C, the annular body 914 of the brazing ring 910 has a substantially uniform cross-sectional thickness throughout the circumference of the ring 910. The ring body 914 follows an angular, wave-like, or zig-zag-style, circular path forming a continuous series or succession of peaks and valleys defining the exterior channels 916 and a series of interior channels 988. The ring body presents a starburst-like profile. The uniform thickness of the body 914 provides the interior surface 942 of the ring 910 with a profile that mimics or follows that of the outer surface 918 to form the series of interior channels 988. The body 914 has an inner diameter 924 and an outer diameter 926 of any desired dimensions. However, the inner diameter 918 is generally selected to closely approximate or be slightly smaller than an outside diameter of the second pipe 874 around which it is adapted to be positioned for a brazing procedure. The thickness of the annular body 914 is preferably selected to ensure that an appropriate volume of brazing material is made available for the brazing procedure.

The exterior or outer channels 916 on the exterior surface 918 of the ring 910 and the inner or interior channels 988 have generally v-shaped cross-sectional profiles which may be rounded or smoothed off at their apexes. Opposing walls 990 of exterior and interior channels 916 and 988 forming the V shape can have any desired angular relationship to provide any number of v-shaped channels 916, 988. For example, the opposing walls 990 of channels 916 may form an angle, θ, that is between about 45° and about 120°, or between about 60° and about 105°, or more preferably form an angle that is approximately equal to about 64°, 87°, 98°, or 103°. An angle φ formed by the opposing walls adjacent the interior channels 988 will generally be smaller than the angle θ.

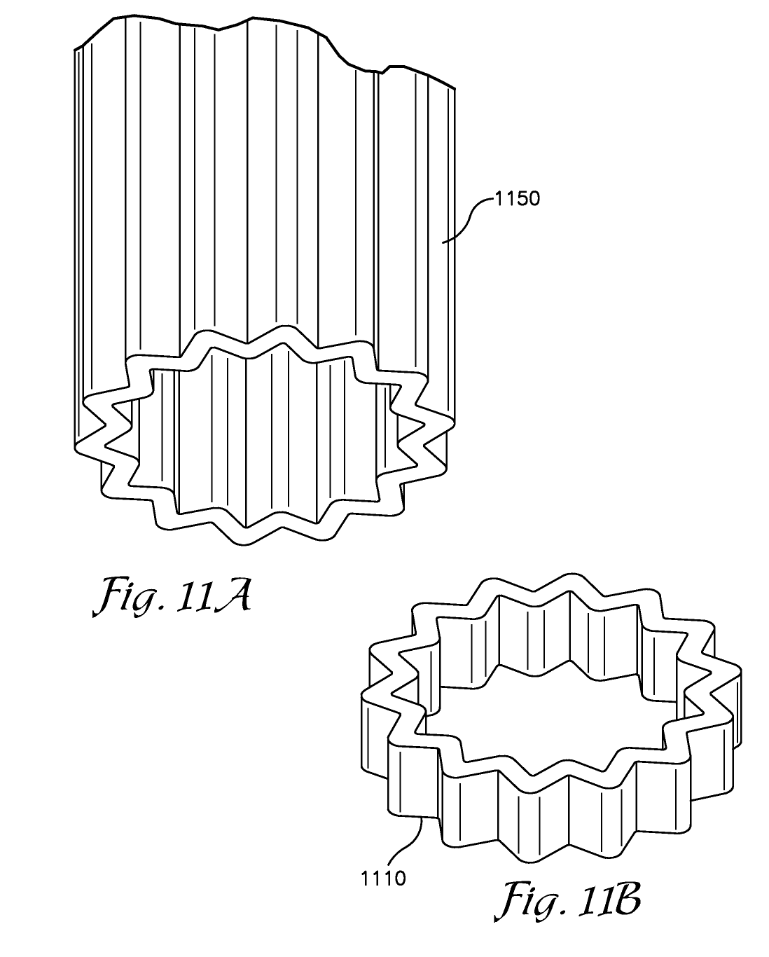

As depicted in FIGS. 10A-B, the brazing ring 910 may be formed from an extruded tube 950 that includes a circular or c-shaped cross-sectional profile. As such, the brazing ring 910 may include a c-shaped profile with a gap 922 between opposing ends or end flanges 936 thereof, as shown in FIG. 10B. Or the extruded tube 910 can be subsequently formed to move the opposing end flanges 936 into close proximity or into contact as depicted in FIGS. 9A-C. Alternatively, a ring 1110, similar to the ring 910, might be formed from an extruded tube 1150 that includes a continuous cross-sectional profile without a gap, as depicted in FIGS. 11A-B.

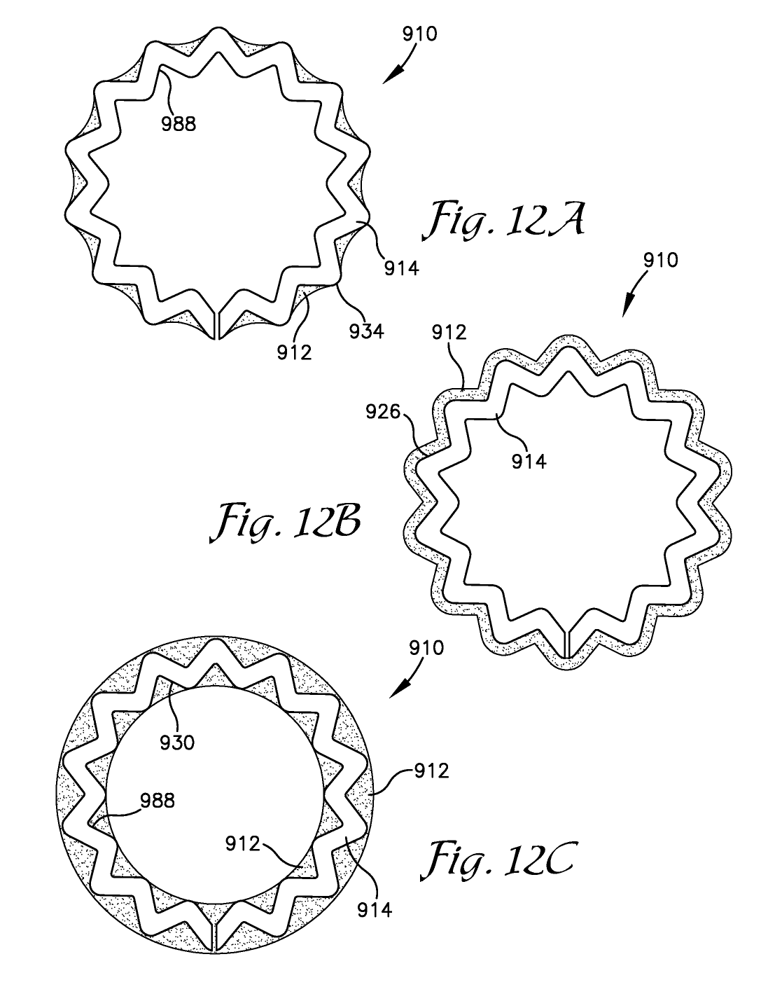

Flux 912 of similar compositions to that described previously is applied to the brazing ring 910 using methods described above. The flux 912 can be applied to the outer surface 918 of the ring 910 in a variety of configurations. For example, the flux 912 can be applied to cover the outer surface 918 but with a majority of the flux 912 lying in the channels 916, as depicted in FIGS. 9A-C. Alternatively, the flux 912 might be disposed only within the channels 916 as shown in FIG. 12A leaving the outer ends or peaks 934 exposed, or the flux 912 might be applied in a layer along the outer surface 918 having a substantially even thickness about the circumference of the ring 910, as depicted in FIG. 12B. In another embodiment depicted in FIG. 12C, the flux 912 is applied to the outer surface 918 in a manner that provides a circular outer profile to the ring 910. Also as depicted in FIG. 12C, the flux 912 might be applied to the inner surface 930 of the ring 910 in any desired configuration.

Operation or use of the brazing ring 910 to join components follows the methods or processes described previously with respect to FIG. 8. The angular or starburst form of the body 914 and/or the constant cross-sectional thickness thereof may aid flowing of the liquid flux 912 during brazing operations. As described previously, upon melting, the flux 912 coats substantially all of the surface of the brazing ring 910 to prepare the ring 910 and/or surfaces of the components to be joined for the brazing operation.

During a brazing operation, the brazing ring 910 is typically disposed on the components to be joined in a substantially vertical orientation similar to the orientations of the rings 910 shown in FIGS. 12A-C. Upon melting of the flux 912, the flux 912 that is disposed along a bottom portion of the ring 910 with respect to the orientation of the ring 910 in the vertical orientation may, due to forces such as surface tension of the liquid flux and/or capillary action, travel upward against gravity and along the face 944 of the ring 910. The liquid flux 912 may also travel along the inner surface 942 of the ring 910 and along the interior channels 988 to provide additional wetting of surfaces of the ring 910 and the component on which the ring 910 is disposed for brazing.

Many different arrangements of the various components depicted, as well as components not shown, are possible without departing from the scope of this description and the claims below. Embodiments of the technology have been described with the intent to be illustrative rather than restrictive. Alternative embodiments will become apparent to readers of this disclosure after and because of reading it. Alternative means of implementing the aforementioned can be completed without departing from the scope of the claims below. Certain features and sub-combinations are of utility and may be employed without reference to other features and sub-combinations and are contemplated within the scope of the claims.

What claimed is:

1. A method for forming an extruded brazing ring with integrated flux, the method comprising:
extruding a filler material to produce a split tube having a circular cross-sectional profile with a gap extending along the length of the tube and with a plurality of channels disposed in and open to an outer surface of and extending along the length of the tube;
disposing a fluxing product in at least one of the channels; and
sectioning the tube perpendicularly to the length thereof to form a brazing ring.

2. The method of claim 1, further comprising performing one or more of a forming and straightening operation on the tube prior to the disposing step.

3. The method of claim 2, wherein the step of performing one or more of a forming and straightening operation on the tube further comprises forming the tube to at least partially close the gap of the tube by moving opposing edges of the tube adjacent the gap toward one another.

4. The method of claim 2, wherein the step of performing one or more of a forming and straightening operation on the tube further comprises forming the tube to close the gap by moving opposing edges of the tube toward and into contact with one another.

5. The method of claim 1, wherein the steps of extruding, disposing, and sectioning are completed in a continuous production line.

6. The method of claim 1, wherein each of the channels formed in the extruding step has a v-shaped cross-section.

7. The method of claim 6, wherein a body of the brazing ring formed by the extruding step has a generally uniform thickness between an outer perimeter and an inner perimeter.

8. The method of claim 7, wherein the extruding step includes producing the split tube to have an inner perimeter that includes a plurality of interior channels having a v-shaped cross-sectional shape.

9. The method of claim 8, wherein the step of disposing the fluxing product in at least one of the channels includes disposing the fluxing product in at least one of the exterior channels and one of the interior channels.

10. A method for forming a plurality of extruded brazing rings, the method comprising;
extruding, via an extrusion press, a filler material to produce a tube having a circular cross-sectional profile, the tube including a plurality of channels disposed in and open to an outer face thereof, the channels extending along the length of the tube;
providing a filling apparatus down-line from the extrusion press to receive the tube following extrusion thereof, the filling apparatus containing a fluxing product;
passing the tube through the filling apparatus;
disposing fluxing product into the channels by the filling apparatus; and
sectioning the tube with fluxing product in the channels thereof perpendicularly to the length of the tube to produce a plurality of brazing rings.

11. The method of claim 10, wherein the tube has a generally uniform thickness between an inner surface and the outer face.

12. The method of claim 11, wherein the extruding step includes producing the tube to include a plurality of interior channels having a v-shaped cross-sectional shape formed around an inner perimeter of the tube.

13. A brazing ring comprising:
an annular body formed from a filler material, the annular body having a pair of opposing faces and having a generally uniform thickness between an inner surface and an outer surface;
a plurality of channels formed in the outer surface of the annular body, the channels extending along the length of the annular body between and perpendicular to the opposing faces; and
a fluxing product disposed in at least one of the channels.

14. The brazing ring of claim 13, further comprising a plurality of interior channels disposed along the inner surface of the body and extending between and perpendicular to the opposing faces.

15. The brazing ring of claim 13, wherein each of the channels has a v-shaped profile.

16. The brazing ring of claim 13, wherein the annular body is circular and includes a gap extending along the length of the body.

17. The brazing ring of claim 13, wherein the annular body has an inner diameter that is less than or the same as an outside diameter of a pipe or fitting on which the brazing ring is to be disposed to provide a friction fit between the body and the pipe or fitting.

18. A ring for use in connecting two metal components together by brazing comprising:
an annular body formed from an alloy adapted for use in brazing, the annular body having opposing faces and inner and outer surfaces;
a plurality of inner and outer channels formed in the inner and outer surfaces respectively of the annular body, the inner and outer channels extending between and perpendicular to the opposing faces and in succession around the annular body.

19. The ring as in claim 18, wherein the thickness of the annular body between the inner and outer surfaces is generally uniform.

20. The ring as in claim 18, wherein said outer channels form a plurality of peaks and valleys extending around an outer periphery of the annular body and projecting outward and said inner channels form a plurality of peaks and valleys extending around an inner periphery of the annular body and projecting inward, wherein the peaks on the outer periphery extend in radial alignment with the valleys in the inner periphery and the peaks on the inner periphery extend in radial alignment with the valleys in the outer periphery.

21. The ring as in claim 20, wherein each of the inner and outer channels has a v-shaped profile.

22. The ring as in claim 21, wherein opposed walls forming the outer channels form an angle of between about 45° and about 120°.

23. The ring as in claim 21, wherein opposed walls forming the outer channels form an angle of between about 60° and about 105°.

24. The ring as in claim 18, wherein at least one of the outer channels is at least partially filled with flux.

25. The ring as in claim 18, wherein each of the outer channels is at least partially filled with flux.
